(19) United States
(12) Patent Application Publication
(10) Pub. No.: US 2025/0347882 A1
(43) Pub. Date: Nov. 13, 2025

(54) FIBER OPTIC CASSETTE CONFIGURED TO PROVIDE ENHANCED ACCESS TO ADAPTERS

(71) Applicant: PPC BROADBAND, INC., East Syracuse, NY (US)

(72) Inventors: Ajay GOPAL, Ernakulam (KL) (IN); Afzal ABDULSALAM, Edathala (KL) (IN)

(73) Assignee: PPC BROADBAND, INC., East Syracuse, NY (US)

(21) Appl. No.: 19/202,918

(22) Filed: May 8, 2025

Related U.S. Application Data
(60) Provisional application No. 63/700,047, filed on Sep. 27, 2024.

(30) Foreign Application Priority Data
May 8, 2024 (IN) 202411036309

(51) Int. Cl. G02B 6/44

(52) U.S. Cl. CPC G02B 6/4453

(57) ABSTRACT

A fiber optic cassette may be configured to provide enhanced access to a fiber optic adapter. The fiber optic cassette may have an adapter access portion that may be coupled with a housing portion. The adapter access portion may move between a closed position that blocks access to an adapter holder portion in the adapter access portion and an open position that permits access to the adapter holder portion. The adapter access portion is structurally configured to pivot about a first hinge pivot portion and a second hinge pivot portion so as to provide enhanced access to a fiber optic adapter held by the adapter holder portion.

### CROSS REFERENCE TO RELATED APPLICATIONS

This application claims the benefit of Indian Provisional Application No. 202411036309, filed in India on May 8, 2024, and U.S. Provisional Application No. 63/700,047, filed on Sep. 27, 2024, both of which are currently pending, the disclosures of which are hereby incorporated by reference herein in their entirety.

### TECHNICAL FIELD

The present disclosure is directed to a fiber optic cassette and, more particularly, to a high density fiber optic cassette configured to provide enhanced access to adapters.

### BACKGROUND

Demand for broadband communications and signal transmission has prompted the expansion and improvement of distributed networks. Such expansion and improvement may correspond with greater numbers of network connections that facilitate network components to provide robust and reliable signal pathways. The establishment and maintenance of relatively large numbers of network connections may pose installation and operation challenges. For instance, increased volumes of network connections that enable signal communication speed and reliability may present numbers of signal-carrying cables that are difficult to organize and protect from environmental threats and inadvertent manual access. In addition, increased volumes of signal-carrying cables may limit the density of cable ports that may be employed by a distributed network, which may restrict the network from achieving peak performance.

Accordingly, a continued goal for distributed networks includes components that provide protected cable organization, greater port density, and increased installation efficiency to allow for consistent and reliable high performance operation.

In some cases, it may be desirable to provide a high density fiber optic cassette that is configured to provide enhanced access to adapters. Some such cases may provide a modular fiber optic cassette having a tray portion, a spool portion that is structurally configured to be coupled with, and uncoupled from, the tray portion, and a cable manager portion that is structurally configured to be coupled with, and uncoupled from, the tray portion so as to permit customization of the cassette.

### SUMMARY

In accordance with various aspects of the disclosure, a fiber optic cassette may provide enhanced access to a fiber optic adapter held by the cassette with a housing portion that may house fiber optic components and an adapter holder portion that may be coupled with the housing portion. An adapter access portion may be coupled with the housing portion at a first end portion of the housing portion. A slack cable storage portion may be coupled with a second end portion of the housing portion opposite the first end portion. The adapter holder portion may hold a fiber optic adapter that may couple fiber optic connectors. The adapter holder portion may extend from the first end of the housing portion. The adapter access portion may receive at least a portion of the adapter holder portion. The adapter access portion may have a base portion and a top access portion that may be movingly coupled with one another by a first hinge portion. The top access portion and the base portion may move relative to one another between an open position of the adapter access portion that permits access to the adapter holder portion and a closed position of the adapter access portion that blocks access to the adapter holder portion. The base portion may have a coupling portion that may couple with the housing portion and a bottom access portion that may be movingly coupled with the coupling portion by a second hinge portion. The top access portion may pivot away from the base portion about the first hinge portion and the bottom access portion may pivot relative to the coupling portion in a direction away from the adapter holder portion so as to provide enhanced access to a fiber optic adapter held by the adapter holder portion while the coupling portion is coupled with the housing portion.

In one or more embodiments of the aforesaid fiber optic cassette, the adapter holder portion may be pivotally coupled with the housing portion.

In one or more embodiments of the aforesaid fiber optic cassettes, the adapter holder portion may comprise a plurality of adapter holders that are configured to pivot relative to one another so as to provide enhanced access to a fiber optic adapter held by the adapter holder portion.

In one or more embodiments of the aforesaid fiber optic cassettes, the fiber optic cassette may comprise a height of one-third of a 1 U height of a fiber optic rack frame.

In one or more embodiments of the aforesaid fiber optic cassettes, the adapter holder portion may comprise six adapter holders, wherein each adapter holder may be configured to hold an LC quad adapter such that the cassette is configured to include 24 LC connector ports.

In one or more embodiments of the aforesaid fiber optic cassettes, the fiber optic cassette may be structurally configured such that six fiber optic cassettes are received in a standard 1 U rack unit so as to provide 144 LC connector ports in a 1 U space.

A fiber optic cassette, in accordance with some embodiments, may provide enhanced access to a fiber optic adapter held by the cassette with a housing portion that may house fiber optic components and an adapter holder portion that may be coupled with the housing portion. An adapter access portion may be coupled with the housing portion at a first end portion of the housing portion. The adapter holder portion may hold a fiber optic adapter that may couple fiber optic connectors. The adapter access portion may receive at least a portion of the adapter holder portion. The adapter access portion may have a base portion and a top access portion that may be movingly coupled with one another by a first hinge portion. The top access portion and the base portion may move relative to one another between an open position of the adapter access portion that permits access to the adapter holder portion and a closed position of the adapter access portion that blocks access to the adapter holder portion. The base portion may have a coupling portion that may couple with the housing portion and a bottom access portion that may be movingly coupled with the coupling portion by a second hinge portion. The top access portion may pivot away from the base portion about the first hinge portion and the bottom access portion may pivot relative to the coupling portion in a direction away from the adapter holder portion so as to provide enhanced access to a fiber optic adapter held by the adapter holder portion while the coupling portion is coupled with the housing portion.

In one or more embodiments of the aforesaid fiber optic cassettes, the adapter holder portion may be structurally configured to rotate about a pivot portion of the housing portion.

In one or more embodiments of the aforesaid fiber optic cassettes, the adapter access portion may be structurally configured to be modularly coupled to the housing portion.

In one or more embodiments, the aforesaid fiber optic cassettes may further comprise a slack cable storage portion structurally configured to be coupled to a second end portion of the housing portion, opposite the first end portion.

In one or more embodiments of the aforesaid fiber optic cassettes, the slack cable storage portion may be structurally configured to position a length of fiber optic cable about a hub portion.

In one or more embodiments of the aforesaid fiber optic cassettes, the hub portion may be structurally configured to rotate to wind, or unwind, cable from the slack cable storage portion.

In one or more embodiments of the aforesaid fiber optic cassettes, the length of fiber optic cable may be connected to the fiber optic adapter of the adapter holder portion by a connector portion of the housing portion.

In one or more embodiments of the aforesaid fiber optic cassettes, the top access portion may be structurally configured to selectively attach to the adapter holder portion

Embodiments of a fiber optic cassette may provide enhanced access to a fiber optic adapter held by the cassette with an adapter access portion that may be coupled with a housing portion. The adapter access portion may move between a closed position that blocks access to an adapter holder portion in the adapter access portion and an open position that permits access to the adapter holder portion. The adapter access portion is structurally configured to pivot about a first hinge pivot portion and a second hinge pivot portion so as to provide enhanced access to a fiber optic adapter held by the adapter holder portion.

In one or more embodiments of the aforesaid fiber optic cassettes, wherein the adapter holder portion may be structurally configured to be coupled with the housing portion.

In one or more embodiments of the aforesaid fiber optic cassettes, the adapter holder portion may be structurally configured to hold a fiber optic adapter that is configured to couple fiber optic connectors.

In one or more embodiments of the aforesaid fiber optic cassettes, the adapter access portion may be structurally configured to receive at least a portion of the adapter holder portion.

In one or more embodiments of the aforesaid fiber optic cassettes, the adapter access portion may comprise a base portion, a bottom access portion, and a top access portion.

In one or more embodiments of the aforesaid fiber optic cassettes, the base portion may include a coupling portion that is structurally configured to couple with the housing portion.

### BRIEF DESCRIPTION OF THE DRAWINGS

Further advantages and features of the present disclosure will become apparent from the following description and the accompanying drawings, to which reference is made.

FIG. 1 is a block representation of portions of a distributed network in which assorted embodiments may be practiced.

FIG. 2 is a line representation of aspects of a rack portion that may be employed in the network of FIG. 1 in various embodiments of this disclosure.

FIG. 3 is a block representation of portions of a cassette portion that may be utilized in the rack portion of FIG. 2 in some embodiments of this disclosure.

FIG. 4 is a perspective, partially exploded, representation of a cassette arranged in accordance with some embodiments of this disclosure.

FIG. 5 is a perspective view of portions of a cassette configured in accordance with assorted embodiments of this disclosure.

FIG. 6 is a side perspective view of a cassette arranged in accordance with various embodiments of this disclosure.

FIG. 7 is a perspective view of portions of a cassette configured in accordance with some embodiments of this disclosure.

FIG. 8 is a perspective view of portions of a cassette arranged in accordance with assorted embodiments of this disclosure.

FIG. 9 is a side cross-sectional view of a cassette configured in accordance with various embodiments of this disclosure.

FIG. 10 is a top view of portions of a cassette arranged in accordance with assorted embodiments of this disclosure.

FIG. 11 is a perspective view of a patch panel portion assembled with cassettes in accordance with various embodiments of this disclosure.

FIG. 12 is a perspective view of a patch panel portion configured and utilized in accordance with some embodiments of this disclosure.

### DETAILED DESCRIPTION

Embodiments may provide a breakout cassette with modular aspects that organize and protect a rotating breakout adapter while presenting excess cabling for selective use. As a result of the use of more than one breakout cassette as part of a patch panel, greater port density may provide a distributed network with increased capabilities, reliability, and efficient access.

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

Distributed networks may arrange hardware components to provide relatively high signal transmission performance and reliability within a relatively small physical footprint. However, positioning large volumes of cable and cable connections in a small physical footprint may pose installation, access, and environmental protection challenges. Hence, may distributed networks employ components that position cables and cable connections with reduced density to mitigate threats and inefficiencies in installation and operation. Accordingly, embodiments are generally directed to distributed network components with increased cable port density along with efficient cable organization, efficient access, efficient installation, and reliable signal transmission.

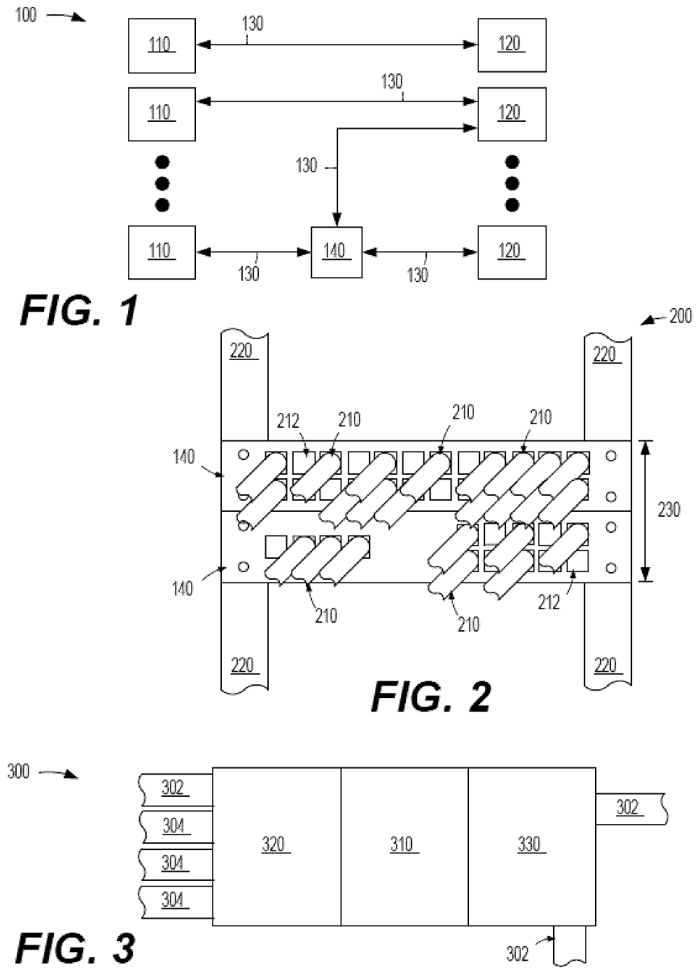

A distributed network 100 is illustrated in FIG. 1. Various embodiments of the present disclosure may be practiced as part of the distributed network 100 to communicate signals between any number of sources 110 and any number of destinations 120. As shown, a single source 110 may be directly connected to a single destination 120 via a unitary signal pathway 130, such as a wired cable or wireless channel.

Yet, the use of individual cables/channels to connect sources 110 to destinations 120 may be spatially inefficient and/or impractical for some residential, commercial, or industrial sites. Thus, one or more network interconnects 140, such as a cassette, adapter, connector, bulkhead, server, electronic device, or combination thereof, may be employed to combine separate cables/channels to provide stable one-way, or two-way signal communications between sources 110 and destinations 120. The ability to join assorted sources 110 and destinations 120 with one or more signal pathways allows for a customizable distributed network 100 that is scalable to serve a variety of different sites, applications, and performance demands.

FIG. 2 illustrates a line representation of portions of a rack portion 200 that may be utilized in the distributed network 100 of FIG. 1 to provide interconnects 140 that unite separate cables 210 to form selected signal pathways. It is noted that the interconnects 140 are each mounted into a rigid rack portion 220 that provides physical support to allow the respective interconnects 140 to engage and support numerous separate cables 210 via cable port portions 212. The interconnects 140 may have matching, or dissimilar, capabilities and structural configurations to provide selective combinations of the network cables 210.

In an effort to increase the capabilities of a distributed network, the respective interconnects 140 may have cable port portions 212 arranged relatively close together, which may be characterized as port density. The density of an interconnect 140 may correlate to the height 240 within the rack portion 220, such as 1 U, 20, or 4 U height distances. The ability to structurally configure an interconnect 140 with a smaller height 230 and greater port density may allow for more efficient use of space and electrical power. However, cable 210 organization and protection of the port portions 212 from environmental threats and inadvertent manual access may be threatened as a result of increasing port portion 212 density, lowering an interconnect's height 230, or placing interconnects 140 close together in a rack portion 220.

With the organizational and operational threats in mind with respect to the goal of increasing rack portion 220 and distributed network capabilities, an interconnect 140 may be arranged with aspects that mitigate such threats while allowing for efficient installation and rework operations by providing slack amounts of cable 210. FIG. 3 illustrates a cassette portion 300 that may be employed in the rack portion 220 of FIG. 2 and/or part of the distributed network 100 of FIG. 1 to provide structural and operational optimizations in accordance with various embodiments. The cassette portion 300 may have any number of input cables 302 and output cables 304 that are joined via one or more aspects of a tray portion 310.

The assorted cables 302/304 may continuously extend into, and out of, the tray portion 310 from a variety of locations, such as from a front, side, or rear side of the cassette portion 300. The front region of the tray portion 310 may be protected from environmental threats and inadvertent manual access by a cable manager portion 320 that selectively closes, or opens, with respect to the tray portion 310. In some embodiments, the cable manager portion 320 substantially, or completely, obscures ports of the tray portion 310 until manual manipulation of aspects of the cable manager portion 320 provides full visual and manual access to the respective ports and other structures of the tray portion 310.

While some embodiments arrange a cassette portion 300 with the tray portion 310 and the cable manager portion 320 to join separate cables 302/304 to form stable signal pathways, other embodiments attach a spool portion 330 onto the tray portion 310 to provide slack cable 302 that may be selectively employed. As such, the cable manager portion 320 and spool portion 330 may be structurally configured to be modular attachments to the tray portion 310 that may be connected, removed, or changed to other structural features at any time.

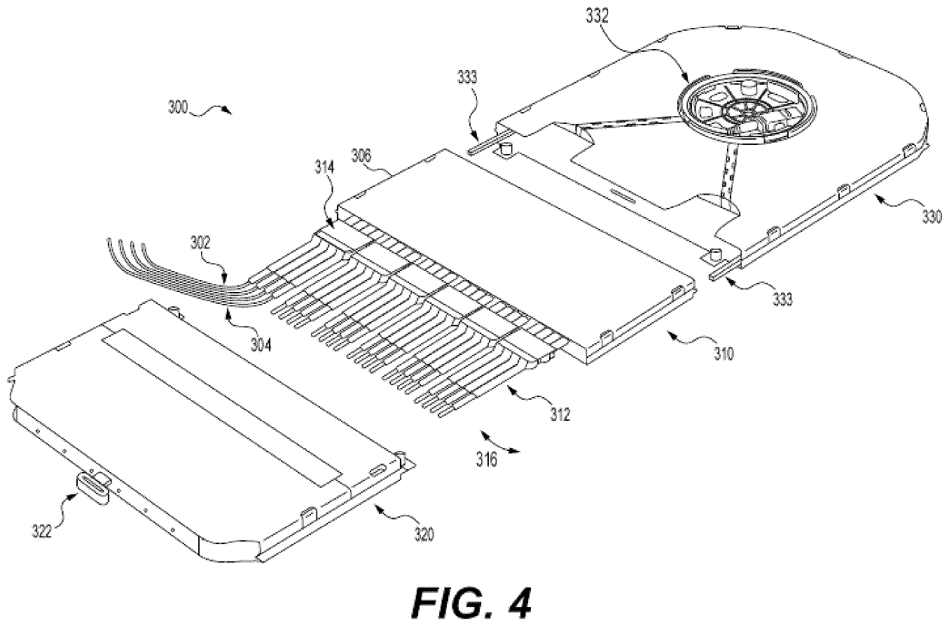

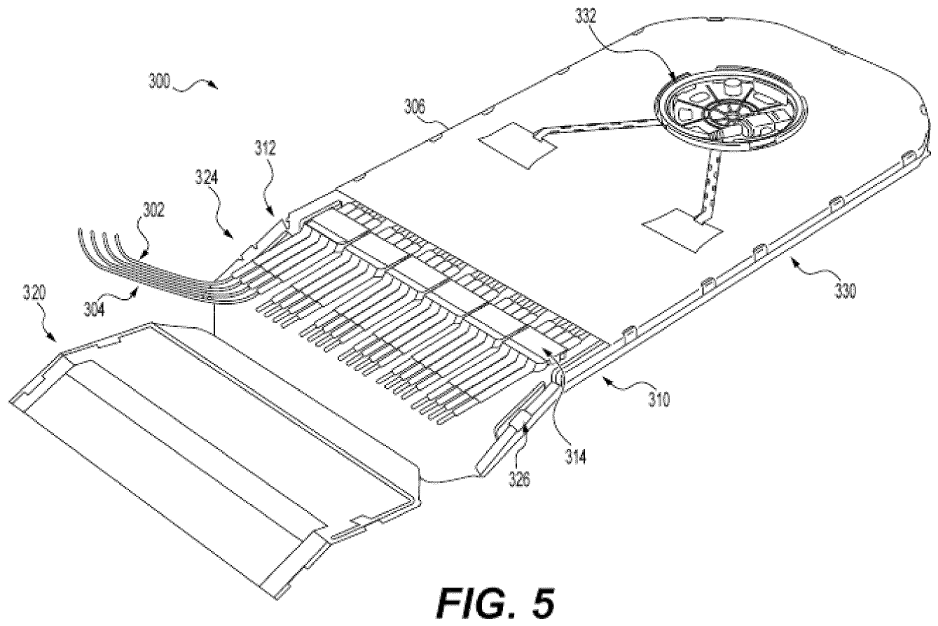

FIG. 4 illustrates a perspective view of the cassette portion 300 of FIG. 3 arranged in accordance with various embodiments. The cassette portion 300 has a unitary cable manager portion 320 that presents a handle portion 322 and selectively hides a connection region 324, as illustrated in FIG. 5, where assorted cables 302/304 physically and optically connect to separate adapter port portions 312 of the tray portion 310. The cable manager portion 320 may provide one or more apertures that allow ingress and egress of the various cables 302/304 to, and from, the respective port portions 312. For instance, the cable manager portion 320 may define apertures that positions cables 302/304 to the lateral sides of the cassette portion 300, as generally shown.

The connection region 324 may have any physical structure and cable port portions 312 that enable formation of one or more stable signal pathways. The respective port portions 312 may be physically supported by one or more adapter holder portion 314 that retain the port portions 312 along a single plane. An adapter holder portion 314 may, in some embodiments, be attached to the tray portion 310 in a manner that allows for rotation within the tray portion 310, as illustrated by arrow 316. The ability to rotate some, or all, of the port portions 312 allows for efficient installation and access without placing physical stress on the port portions 312, cables 302/304, or tray portion 310 that jeopardize the integrity or operation of the cassette portion 300.

While the tray portion 310 may alone operate to join separate cables 302/304, some embodiments attach the spool portion 330 to the tray portion 310 via one or more connection features 333, such as tabs, arms, fasteners, or other mechanisms, that allow for secure, and selectable, attachment. The spool portion 330 may provide one or more continuous lengths of cable 332 that may be selectively utilized to electrically connect to the adapter port portions 312. That is, the spool portion 330 may allow for selective extension of a cable 332 from the cassette portion 300, which may optimize installation, connectivity, and compatibility. The storage of the extending cable 332 in the spool portion 330 may further optimize the physical space occupied by the cassette portion 300 compared to using a loose, uncontained cable 302/304 that may contribute to cable disorganization.

FIG. 5 illustrates a perspective view of the cassette portion 300 of FIG. 4 arranged in accordance with various embodiments. It is noted that the respective portions 310/320/330 of the cassette portion 300 that are shown in FIG. 4 in an exploded configuration are shown in FIG. 5 physically joined. Yet, the physically combined cassette portion 300 of FIG. 5 does not limit or restrict modularity or the ability to remove and/or change a portion 310/320/330.

As shown, the cable manager portion 320 is opened in FIG. 5 to reveal the assorted port portions 312 of the tray portion 310. The cable manager portion 320 is constructed as a unitary member that folds open without presenting any detached pieces or components. As such, a technician may visually and physically access the assorted port portions 312 without having to manage or control aspects of the cable manager portion 320. The cable manager portion 320, in some embodiments, has a physical configuration with a top access portion, a base portion, and a bottom access portion, which may be separated by a first hinge and a second hinge. The cable manager portion 320 may be characterized, in some embodiments, as an adapter access portion that provides a substantially sealed connection region 324 while other embodiments may structurally configure the cable manager portion 320 to restrict physical and visual access to the port portions 312 without hampering airflow, which may contribute to maintaining the tray portion 310 within a predetermined thermal range.

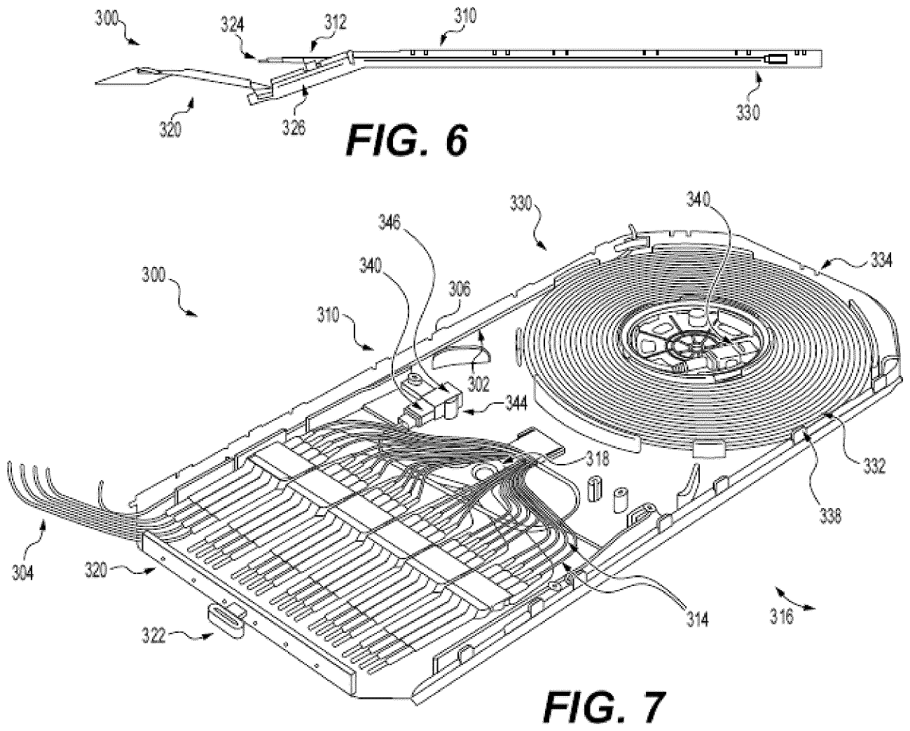

It is noted that the cable manager portion 320, in some embodiments, has a bottom portion and a top portion that are attached via a hinge that allows for manipulation of the respective portions relative to one another as well as relative to the tray portion 310. As shown in FIGS. 5 and 6, the cable manager portion 320 may allow selective access to the adapter holder portion 314, which may be characterized as a coupling portion in some embodiments, and any port portions 312 and/or adapters, when in an open position. In a closed position, as shown in FIG. 4, the cable manager portion 320 may provide cover and protection for the adapters and the adapter holder portion 314.

The side profile view of the cassette portion 300 in FIG. 6 conveys how the cable manager portion 320 may open to reveal the port portions 312 without hindering or restricting access to the port portions 312. It is contemplated that the cable manager portion 320 has one or more label regions that present text, drawings, or other information, such as port identification or capabilities. With the cable manager portion 320 structurally configured to open and expose the respective port portions 312 while being positioned below the plane of the port portions 312, the cable manager portion 320 does not restrict access to the port portions 312. It is noted that one or more closure portions 326, which may be characterized as part of a coupling portion of the cable manager portion 320 in some embodiments. The closure portions 326, such as a snap, tab, key, lock, or other selectable retention mechanism, may be included into the cable manager portion 320 to allow secure closure over time.

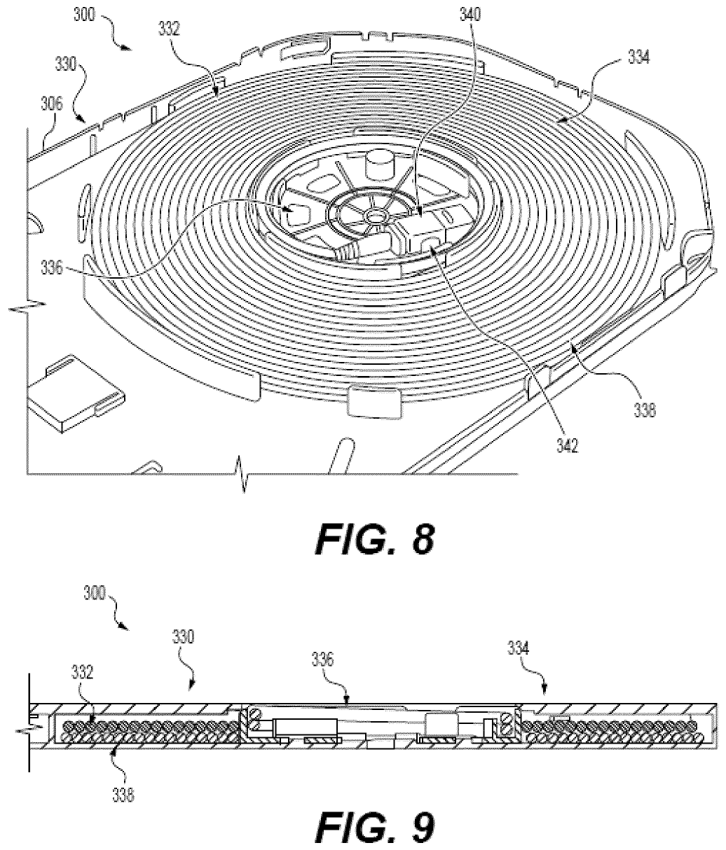

In the perspective view of FIG. 7, aspects of the cassette portion 300 are removed to expose how the adapter holder portion 314 and cable spool 334 are positioned within the cassette housing 306. The adapter holder portion 314 is attached to the housing portion 306 via a central pivot portion 318 while the cable spool 334 includes a centrally mounted hub portion 336 surrounded by a cable retention portion 338, as illustrated in FIG. 8. The adapter holder portion 314, as shown, physically positions and supports a number of separate adapter holder portions 314, which may include adapters and cable ports, such as SC, LC, quad, duplex, or simplex ports, while allowing for selective rotation 316 about the housing portion 306.

In accordance with some embodiments, the adapter holder portion 314 may support 24 separate port portions 312 that are collectively joined to a spool connector 340 that unites the port portions 312 to the spool cable 332. As such, the spooled cable 332 may provide input of 24 fiber optic cores that are separated by the respective ports 312 into individual output cables 304. The separation of fiber optic cores from the spool connector 340 to the assorted output cables 304 via the respective port portions 312 may be characterized as a breakout feature of the cassette portion 300.

The detailed perspective view of the spool portion 330 in FIG. 8 conveys how the spool cable 332 may be continuously wrapped around the spool hub portion 336, which corresponds with a slack length of the cable 332 that may be removed from the cassette housing 306 upon selection. During such slack cable 332 removal, the spool hub portion 336 may rotate to allow efficient cable 332 dispensing. Subsequently, the rotating hub portion 336 may allow for efficient cable 332 retraction and storage in the retention portion 338, as illustrated in the cross-sectional view of FIG. 9. As a result, the spool portion 330 may have a relatively small height while providing a relatively long continuous length of slack cable 332.

The spool hub portion 336 is structurally configured with a holder portion 342 that is arranged to retain the spool connector 340 while the spool 334 is in use. In other words, the spool connector 340, which is connected to the spool cable 332, is retained in place on the spool hub portion 336 by the holder portion 342 until a selected length of cable 332 is delivered from the cassette housing portion 306. Various embodiments structurally configure the spool hub portion 336 to allow for manual and/or automated rotation to provide a selected length of cable 332 for input of fiber optic cores that are separated by the tray portion 310 into individual output cables 304.

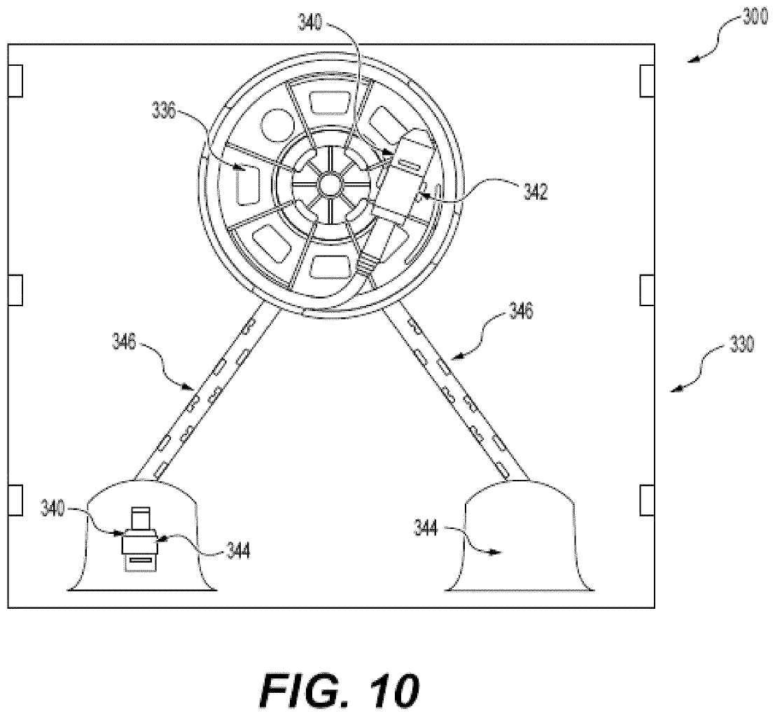

As illustrated in FIG. 10, once a length of spool cable 332 is administered by rotating the spool hub portion 336, the spool connector 340 may be removed from the holder portion 342 and connected to an adapter positioned in a retention portion 344 to allow for efficient connection with the respective port portions 312 of the tray portion 310. Some embodiments arrange the retention portion 344 to be filled with an adapter 346 that allows for connection of the connector 340 while other embodiments provide a mounting location for the spool connector 340. Conversely, placement of the connector 340 in the holder portion 342 allows for aspects of the slack cable 332 to be extended, or retracted, via rotation of the spool hub portion 336.

While not required or limiting, placement of the spool connector 340 in the retention portion 344 may correspond with articulation of the attached cable 332 into a cable retaining portion 346 that may be structurally configured as a continuous groove with a series of separated protrusions to contact and secure the cable 332. As shown in FIG. 10, the spool portion 330 may be arranged with several separate retention portions 344 and cable retaining portions 346 to allow for different positions for the spool connector 340 in relation to the adapter holder portion 314 of a retention portion 310. It is contemplated that the different retention portions 344 may allow for selective operation of a adapter holder portion 314, such as range of rotation or rotation biasing.

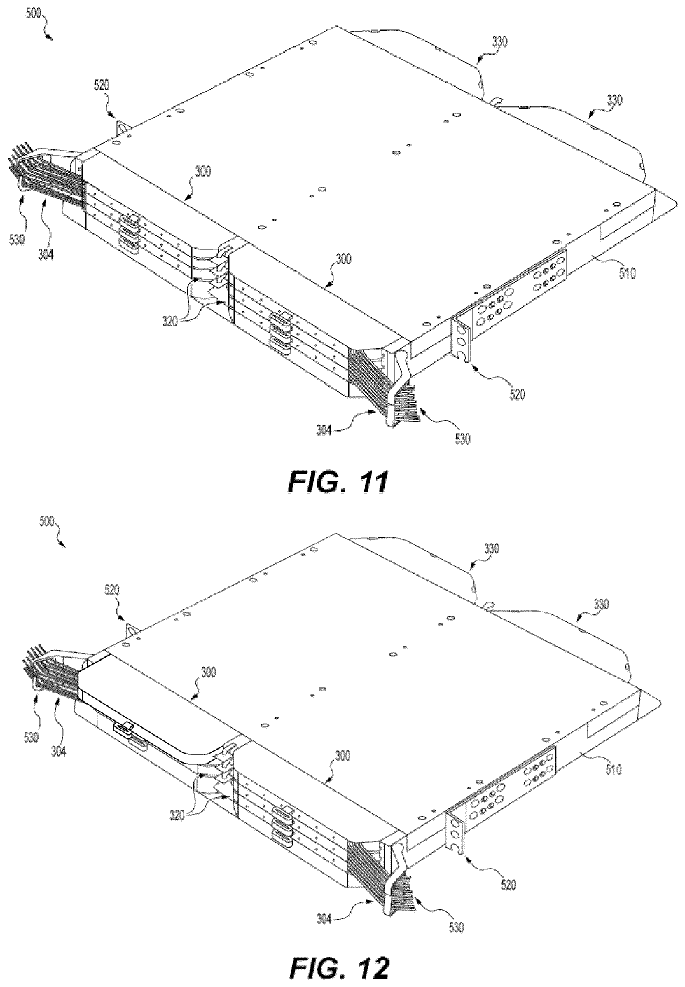

Through the structural embodiments of a cassette portion 300, cable ports may be protected with a cover, rotate within a housing, and have slack cable available for use within a relatively small physical footprint and height. That is, the arrangement of the retention portion 310, cable manager portion 320, and spool portion 330 in a small height allows for the incorporation of multiple cassette portions 300 in a single rack portion, as shown in FIG. 11. The perspective view of the patch panel portion 500 in FIG. 11 illustrates how a rack frame portion 510 with a 1 U height may concurrently contain multiple separate cassette portions 300 while providing a mounting portion 520 that allows for the secure physical attachment of the frame portion 510 to a rigid mount, such as the rack portion 220.

Despite secure physical retention of the respective cassette portions 300 within the rack frame portion 510, individual cassette portion 300 may be accessed at any time. For instance, a single cassette portion 300 may be partially removed from the rack frame portion 510, as illustrated in FIG. 12, and opened to expose port portion s 312 and/or utilize slack cable 332 as an input cable 302 that is expanded into individual output cables 304 by the port portions 312 of the tray portion 310. It is noted that the view of FIG. 11 conveys how the cable manager portion 320 of each cassette portion 300 defines a cable 304 aperture that directs and organizes output cables 304 into a rack loom portion 530 that further secures and organizes the respective output cables 304. As a result of the structural configuration of the rack frame portion 510, cassette portion 300 installation, alteration, and operation may be optimized for efficiency while providing port protection and available slack cable 332.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A fiber optic cassette configured to provide enhanced access to a fiber optic adapter held by the cassette comprising:
a housing portion structurally configured to house fiber optic components;
an adapter holder portion structurally configured to be coupled with the housing portion;
an adapter access portion structurally configured to be coupled with the housing portion at a first end portion of the housing portion;
a slack cable storage portion structurally configured to be coupled with a second end portion of the housing portion opposite the first end portion;
wherein the adapter holder portion is structurally configured to hold a fiber optic adapter that is configured to couple a fiber optic connector;
wherein the adapter holder portion is configured to extend from the first end of the housing portion;
wherein the adapter access portion is structurally configured to receive at least a portion of the adapter holder portion;
wherein the adapter access portion includes a base portion and a top access portion structurally configured to be movingly coupled with one another by a first hinge portion;
wherein the top access portion and the base portion are structurally configured to move relative to one another between an open position of the adapter access portion that permits access to the adapter holder portion and a closed position of the adapter access portion that blocks access to the adapter holder portion;
wherein the base portion includes a coupling portion structurally configured to couple with the housing portion, and a bottom access portion structurally configured to be movingly coupled with the coupling portion by a second hinge portion; and
wherein the top access portion is structurally configured to pivot away from the base portion about the first hinge portion and the bottom access portion is structurally configured to pivot relative to the coupling portion in a direction away from the adapter holder portion so as to provide enhanced access to a fiber optic adapter held by the adapter holder portion while the coupling portion is coupled with the housing portion.

2. The fiber optic cassette of claim 1, wherein the adapter holder portion is pivotally coupled with the housing portion.

3. The fiber optic cassette of claim 2, wherein the adapter holder portion comprises a plurality of adapter holders that are configured to pivot relative to one another so as to provide enhanced access to a fiber optic adapter held by the adapter holder portion.

4. The fiber optic cassette of claim 1, wherein the fiber optic cassette comprises a height of one-third of a 1 U height of a fiber optic rack frame.

5. The fiber optic cassette of claim 1, wherein the adapter holder portion comprises six adapter holders, wherein each adapter holder is configured to hold an LC quad adapter such that the cassette is configured to include 24 LC connector ports.

6. The fiber optic cassette of claim 1, wherein the fiber optic cassette is structurally configured such that six fiber optic cassettes are received in a standard 1 U rack unit so as to provide 144 LC connector ports in a 1 U space.

7. A fiber optic cassette configured to provide enhanced access to a fiber optic adapter held by the cassette comprising:
a housing portion structurally configured to house fiber optic components;
an adapter holder portion structurally configured to be coupled with the housing portion;
an adapter access portion structurally configured to be coupled with the housing portion at a first end portion of the housing portion;
wherein the adapter holder portion is structurally configured to hold a fiber optic adapter that is configured to couple a fiber optic connector;
wherein the adapter access portion is structurally configured to receive at least a portion of the adapter holder portion;
wherein the adapter access portion includes a base portion and a top access portion structurally configured to be movingly coupled with one another by a first hinge portion;
wherein the top access portion and the base portion are structurally configured to move relative to one another between an open position of the adapter access portion that permits access to the adapter holder portion and a closed position of the adapter access portion that blocks access to the adapter holder portion;
wherein the base portion includes a coupling portion structurally configured to couple with the housing portion, and a bottom access portion structurally configured to be movingly coupled with the coupling portion by a second hinge portion; and
wherein the top access portion is structurally configured to pivot away from the base portion about the first hinge portion and the bottom access portion is structurally configured to pivot relative to the coupling portion in a direction away from the adapter holder portion so as to provide enhanced access to a fiber optic adapter held by the adapter holder portion while the coupling portion is coupled with the housing portion.

8. The fiber optic cassette of claim 7, wherein the adapter holder portion is structurally configured to rotate about a pivot portion of the housing portion.

9. The fiber optic cassette of claim 7, wherein the adapter access portion is structurally configured to be modularly coupled to the housing portion.

10. The fiber optic cassette of claim 7, further comprising a slack cable storage portion structurally configured to be coupled to a second end portion of the housing portion, opposite the first end portion.

11. The fiber optic cassette of claim 10, wherein the slack cable storage portion is structurally configured to position a length of fiber optic cable about a hub portion.

12. The fiber optic cassette of claim 11, wherein the hub portion is structurally configured to rotate to wind, or unwind, cable from the slack cable storage portion.

13. The fiber optic cassette of claim 11, wherein the length of fiber optic cable is connected to the fiber optic adapter of the adapter holder portion by a connector portion of the housing portion.

14. The fiber optic cassette of claim 7, wherein the top access portion is structurally configured to selectively attach to the adapter holder portion.

15. A fiber optic cassette configured to provide enhanced access to a fiber optic adapter held by the cassette comprising:
an adapter access portion structurally configured to be coupled with a housing portion;
wherein the adapter access portion is structurally configured to move between a closed position that blocks access to an adapter holder portion in the adapter access portion and an open position that permits access to the adapter holder portion; and
wherein the adapter access portion is structurally configured to pivot about a first hinge pivot portion and a second hinge pivot portion so as to provide enhanced access to a fiber optic adapter held by the adapter holder portion.

16. The fiber optic cassette of claim 15, wherein the adapter holder portion is structurally configured to be coupled with the housing portion.

17. The fiber optic cassette of claim 15, wherein the adapter holder portion is structurally configured to hold a fiber optic adapter that is configured to couple fiber optic connectors.

18. The fiber optic cassette of claim 15, wherein the adapter access portion is structurally configured to receive at least a portion of the adapter holder portion.

19. The fiber optic cassette of claim 15, wherein the adapter access portion comprises a base portion, a bottom access portion, and a top access portion.

20. The fiber optic cassette of claim 19, wherein the base portion includes a coupling portion that is structurally configured to couple with the housing portion.
